(19) United States
(12) Patent Application Publication
(10) Pub. No.: US 2007/0227066 A1
(43) Pub. Date: Oct. 4, 2007

(54) Container and liner for side-planting plants and a method for same

(76) Inventor: Pamela Crawford, Lake Worth, FL (US)

Correspondence Address: The Intellect Law Group, 2400 SE Federal Highway, Suite 340, Stuart, FL, 34994, US

(21) Appl. No.: 11/395,002

(22) Filed: Mar. 31, 2006

(51) Int. Cl. A01G 9/02

(52) U.S. Cl. 47/65.5

(57) ABSTRACT

This invention relates to the design and construction of a novel container and liner for side-planting plants in container gardens. This invention further relates to a method for side-planting plants in containers.

### FIELD OF THE INVENTION

This invention relates to the design and construction of a novel container and liner for side-planting plants in container gardens. This invention further relates to a method for side-planting plants in containers.

### BACKGROUND OF THE INVENTION

Container gardening is an increasingly popular gardening technique. Many containers are constructed of wire forms lined with coco-fiber, or a similar material that keeps the soil from falling out from between the wires; these are well-known in the prior art.

Traditionally, a gardener will use a wire form container lined with a rigid liner designed specifically to only allow plants to be planted in the top of the container with the liner left visible through the sides of the container. Seedlings can be pushed through the sides, but they take months to grow full and are difficult to fit through the common, hard liners.

A major disadvantage attributable to the design and construction of prior art containers and pre-formed liners is that the prior art containers and pre-formed liners only allow the plants to be planted in the top of the containers, which leaves the unattractive liners showing through the sides of the containers. It typically will take months before the top-planted plants will grow long enough to cover the sides of the container and the liner.

The prior art containers and liners also are not designed to accommodate side-planted plants because the spacing of the wires are not sized to allow the passage of the root balls of non-seedling and substantially mature plants through the sides of the containers and are not spaced correctly to prevent over planting, which causes plants to die quickly. Additionally, most traditional liners are not designed to allow the root balls of non-seedling and substantially mature plants to be inserted through the sides of the liners. Most liners are formed of solid materials and are designed to prevent the plants and soil from falling trough the wire forms.

In view of the prior arts' shortcomings, it is thus desirable to create a method of side-planting plants in containers so that the containers will cover the liners and appear full immediately. Moreover, there is clearly a need for a container and liner product that will provide a means for accomplishing the side-planting method, as the prior art containers and liners are not designed to accommodate side planting of non-seedling and substantially of mature plants.

### SUMMARY OF THE INVENTION

The inventive structure presents a number of advantages over the prior art. First, the invention is simple to form. The container may be formed from any material that will allow sufficient space between each opening to allow passage of a root ball through the container sides and the liner, such as but not limited to, wire, plastic, metal, and the like. The liner is pre-cut with a specific-sized hole and slits that will allow the passage of a root ball and also prevent the root ball and soil from falling out of the container after it has been inserted. The liner may be formed of any material that can be pre-cut, such as but not limited to, coco fiber liners, plastic, and the like.

Another advantage to the container is that it is designed specifically for the method of side planting, and the container and liner act as a guide to prevent users from over planting, which causes the plants to die. This feature is particularly useful because most gardeners are novice and while they would enjoy having a container garden, it can be very difficult to plant and maintain a container garden without a lot of experience. The present invention will provide a simple and effective guide for novice container gardens thus decreasing the chance of error.

The method of side planting is advantageous over the traditional methods of top-only planting because the method of side planting allows the user to create a container plant that appears full immediately whereas top-only planting results in the sides of the container being visible until the top plants grow long enough to cover the sides of the container. The top-only planting method thus creates a less attractive container plant.

Using the present method of side planting, a user first places a liner in a container if the liner and container are not already pre-assembled. The user fills the liner with soil until it reaches near the bottom of the first pre-cut hole in the liner. Then the user inserts a root ball through a liner hole and allows the root ball to rest on the top of the soil. The user repeats the step of inserting a root ball through a liner hole and allowing the root ball to rest on the top of the soil until all pre-cut holes in the liner have been filed. The user then fills the liner with soil to cover the side planted root balls. After the user has completed one of more layers of side planting, the user may complete the container by top-planting plants in the top of the container.

### BRIEF DESCRIPTION OF THE DRAWINGS

FIG. 1 is a depiction of a prior art top-planted container and liner.

FIG. 2 is a view of a single-layer container and liner according to the embodiments described herein.

FIG. 3 is a view of a multiple-layer container and liner according to the embodiments described herein.

FIG. 4 is a view of a root ball being inserted through a container opening and pre-cut liner hole.

FIG. 5 is a completed view of a side-planted plant and container subsequent to insertion.

### DETAILED DESCRIPTION OF THE INVENTION:

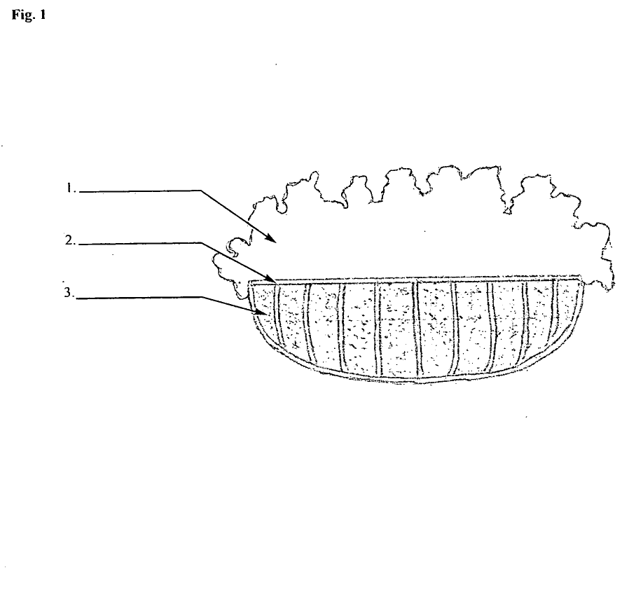

Shown in FIG. 1 is a depiction of a prior art top-planted container and liner. The plants (1) are planted in the top of the wire form container (2), which is lined with a solid liner (3) that is designed to prevent the plants (1) and soil from falling through the spaces between the wires of the wire form container (2).

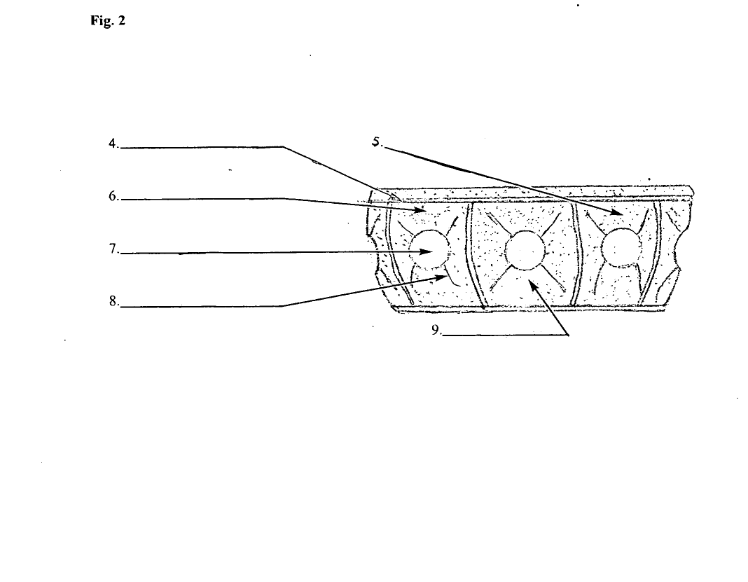

Shown in FIG. 2 is a drawing of the present invention. The container (4) is formed of openings (5) spaced to allow the passage of one root ball through the side of the container (4) and the liner (6). In the preferred embodiment, the openings (5) are spaced about 3.5″×3.5″ at a minimum and 7″×7″ at a maximum. In the preferred embodiment, the vertical angle of the container sides may vary from about 60 degrees to 90 degrees to ensure that the bottom plants receive enough light to grow.

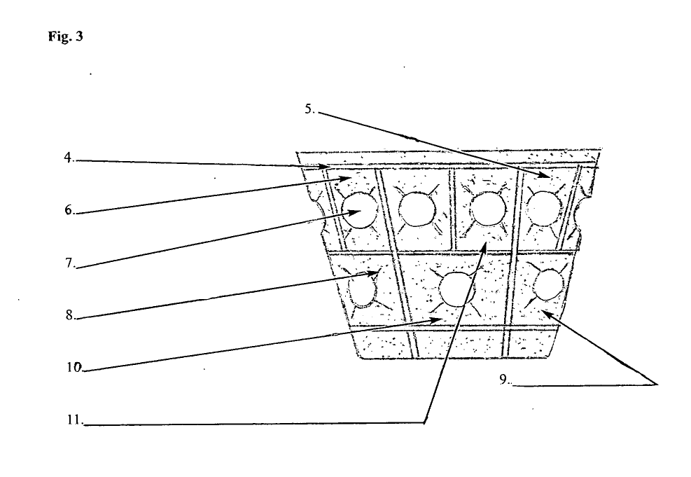

The liner (6) is pre-cut with specific-sized holes to allow the passage of the root ball through the side of the liner and to prevent the root ball and soil from falling out of the container after its insertion. In the preferred embodiment, the pre-cut holes (7) are about 1.5″ and have about a 1″ slit (8) extending from one or more sides of each pre-cut hole (7), which creates one or more flaps (9) around each pre-cut hole (7). The flaps (9) allow the root ball (12) to be pushed through the pre-cut holes (7) and then retract to prevent the root ball (12) and soil from falling out of the container (4). The pre-cut holes (7) in the liner (6) also act as a guide for users to prevent the users from over planting the container, which will cause the plants to die. The container (4) may be formed of one layer, as depicted in FIG. 2, or may consist of multiple layers, as shown in FIG. 3. In the preferred embodiment of the multiple layer container shown in FIG. 3, the bottom openings (10) are larger than the openings above (11) to prevent the plants from dying as a result of being planted too closely.

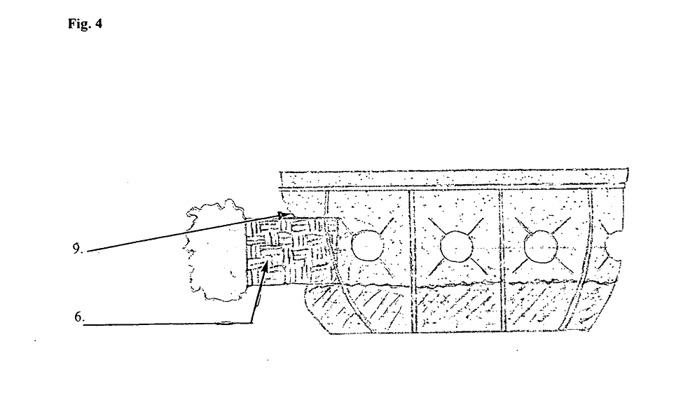

Referring now to FIG. 4, the root ball (12) of a mature plant (13) is shown being inserted through a container (4) opening (5) and a pre-cut hole (7) in the liner (6).

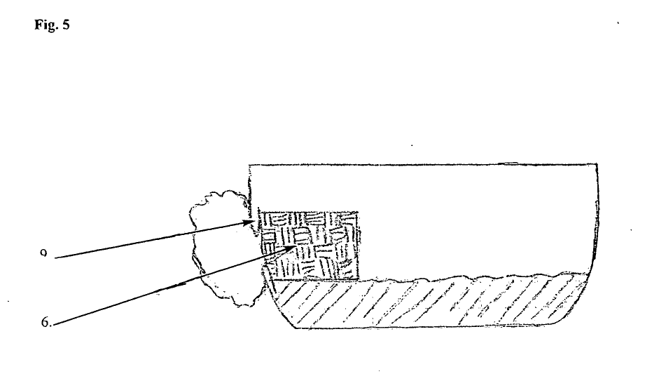

Referring now to FIG. 5, the root ball (12) of a mature plant (13) is now fully inserted through the container (4) opening (5) and a pre-cut hole (7) in the liner (6), with the plant top-growth decorating the exterior portions of the container.

What is claimed:

1. A container and liner comprising:
a container with a plurality of openings on the sides of the container and;
a liner with a plurality of pre-cut holes sized to accept and retain the root ball of a non-seedling or substantially mature plant.

2. A container and liner as described in claim 1 wherein said container is a hanging basket.

3. A container and liner as described in claim 1 wherein said container is a basket on a stand.

4. A container and liner as described in claim 1 wherein said container is a wall pot.

5. A container and liner as described in claim 1 wherein said container is a window box.

6. A container and liner as described in claim 1 wherein said container is a two-tiered planter.

7. A container and liner as described in claim 1 wherein said container is a three-tiered planter.

8. A container and liner as described in claim 1 wherein said container is a patio planter on legs.

9. A container and liner as described in claim 1 wherein the container openings are spaced no less than 3.5″×3.5″.

10. A container and liner as described in claim 1 wherein the container openings are spaced no more than 7″×7″.

11. A container and liner as described in claim 1 wherein the sides of the container are at a vertical angle no less than 60 degrees.

12. A container and liner as described in claim 1 wherein the sides of the container are at a vertical angle no more than 90 degrees.

13. A container and liner as described in claim 1 wherein the container is comprised of multiple layers of openings.

14. A container and liner as described in claim 1 wherein the container openings are larger on the bottom layer.

15. A container and liner as described in claim 1 wherein the container openings become smaller as they ascend to the top of the container.

16. A container and liner as described in claim 1 wherein the liner has pre-cut holes measuring about 1.0″ to 2.0″ in diameter.

17. A container and liner as described in claim 1 wherein the liner has at least one approximately 1″ slit extending from the sides of the pre-cut holes.

18. A liner with a plurality of pre-cut holes sized to accept and retain the root ball of a plant.

19. A liner as described in claim 2 wherein the liner has pre-cut holes measuring about 1.0″ to 2.0″ in diameter.

20. A liner as described in claim 2 wherein the liner has at least one approximately 1″ slit extending from the sides of the pre-cut holes.

21. A method of side planting plants in a container, said method comprising the steps of:
placing a liner in a container;
filling the liner with soil until it reaches about the bottom of the first opening in the liner;
inserting a root ball through a liner opening and resting the root ball on top of the soil;
repeating the step of inserting a root ball through a liner opening and resting the root ball on the top of the soil until all openings in the liner have been filled; and
filling the liner with soil to cover the side planted root balls.

22. The method a described in claim 21 and further comprising the step of placing the liner such that the top of the liner extends about 0.5″ to 1″ above the container rim.

23. The method as described in claim 21 and further comprising the step of placing the liner holes such that
